(19) United States
(12) Patent Application Publication
(10) Pub. No.: US 2008/0225780 A1
(43) Pub. Date: Sep. 18, 2008

(54) USE OF DISTRIBUTED HASHTABLES FOR WIRELESS ACCESS MOBILITY MANAGEMENT

(75) Inventors: William C. McCORMICK, Ottawa (CA); Michael A. ROGER, Nepean (CA); Alfred R. SCHMIDT, Calgary (CA); James F. WIMBERLEY, Kanata (CA); Karl D. MANN, Nepean (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: NORTEL NETWORKS LIMITED, St-Laurent (CA)

(21) Appl. No.: 11/955,994

(22) Filed: Dec. 13, 2007

Related U.S. Application Data
(60) Provisional application No. 60/894,528, filed on Mar. 13, 2007.

(51) Int. Cl. H04Q 7/00

(52) U.S. Cl. 370/328

(57) ABSTRACT

A method, apparatus and system for management of a wireless communication network in which the system has a plurality of access nodes. A distributed hash table (“DHT”) is created. The DHT contains mobility management data of mobile devices using the wireless communication network. The DHT is stored across at least a portion of the plurality of access nodes.

### CROSS-REFERENCE TO RELATED APPLICATION

This application is related to and claims priority to U.S. Provisional Patent Application Ser. No. 60/894,528, filed Mar. 13, 2007, entitled Use of Distributed Hash Tables for Wireless Access Mobility Management, the entirety of which is incorporated herein by reference.

### STATEMENT REGARDING FEDERALLY SPONSORED RESEARCH OR DEVELOPMENT

n/a

### FIELD OF THE INVENTION

The present invention relates to wireless network communications and in particular to a method and system for simplifying or eliminating the central management node in wireless communication networks.

### BACKGROUND OF THE INVENTION

Wireless communication networks, e.g., orthogonal frequency division multiple access (“OFDMA”) networks, are used to support cell-based voice and high speed services such as those under certain standards such as the 3rd Generation Partnership Project (“3GPP”) and 3GPP2 evolutions, e.g. Evolved Universal Terrestrial Access Network (E-UTRAN)/Evolved Packet Core (EPC), the Ultra-Mobile Broadband (“UMB”) broadband wireless standard and the IEEE 802.16 standards. The IEEE 802.16 standards are often referred to as WiMAX or less commonly as WirelessMAN or the Air Interface Standard. These networks include a plurality of base stations or other access nodes that engage in wireless communication with one or more mobile devices, such as a cell phone, smartphone, portable computer, etc. These wireless networks are arranged to maintain a communication session with a destination device even when the mobile device moves from an area, e.g., cell, supported by one access node, e.g., base station, to an area supported by another access node. This movement of the communication session from one access node to another is typically referred to as a “handoff”.

Wireless communication networks use a financially expensive and management intensive centralized management node, e.g., base station controller (“BSC”), radio network controller (‘RNC”), WiMax access service network (“ASN”) gateway, etc., (1) to manage the handoff function, (2) for idle mobile device location management, (3) to manage paging of mobile devices for incoming calls and (4) to manage access into the wireless communication network. These functions are referred to as mobility management functions. The centralized node is located within the network such that it engages data communication with the access nodes to provide these functions. However, it is desirable to have a system and method for a wireless communication network that eliminates the need for a centralized node to provide the mobility management functions.

In viewing this problem, it may occur to those of skill in the art that a simple solution is to simply have each access node replicate all of its data relating to mobility management (“mobility data”) to every other access node in the wireless communication network. However, it is readily observable that such an arrangement is expensive due to the need for extremely powerful (both from a computational capacity as well as a memory storage capacity) access nodes. In addition to being expensive, such an arrangement does not scale well because the volume of messaging that would be required between the access nodes grows geometrically with quantity of access nodes present in the network. As such, a network with a large number of access nodes would end up consuming a significant portion of the available bandwidth between access nodes with mobility management messaging traffic. Of course, the bandwidth between access nodes is better used to support revenue generating customer communication session data. Accordingly, it is also desirable to have a method and system that allows access nodes to efficiently and scalably provide mobility management functions.

### SUMMARY OF THE INVENTION

The present invention advantageously provides a method and system for simplifying or eliminating the centralized management node in wireless communication networks by using a distributed database at the wireless access nodes.

In accordance with the present invention, a distributed hash table is implemented to store mobility management information for a wireless access network. The DHT is stored on at least a portion of the access nodes in the network. Each node is assigned a unique NODEID which is used as one of a set of keys to organize the DHT.

In one first embodiment of the invention, mobility management information is stored in the DHT by processing some unique id of the mobile device against the set of keys to determine on which node to store the information. When mobility management information is needed, the id of the mobile device is processed against the set of keys to determine which nodes should have the information. The manner in which the mobile device id is processed is the same in both instances, so that the DHT may be used to store and retrieve mobility management information from the network without relying on a central node. The DHT may be implemented to store mobile device session data, mobile device location data, diversity handoff anchor points or other information of interest to the network.

In another embodiment of the invention, paging zone information is stored in the DHT by processing some unique id of the paging zone against the set of keys to determine on which node to store the information. When paging zone information is needed, the paging zone id is processed against the set of keys to determine which nodes should have the information. The DHT may be implemented to store the list of access points in a paging zone in a manner to facilitate paging requests without the need for a central node.

In accordance with one aspect, the present invention provides a method for management of a wireless communication network having a plurality of access nodes. A distributed hash table (“DHT”) is created. The DHT contains mobility management data of mobile devices using the wireless communication network. The DHT is stored across at least a portion of the plurality of access nodes.

In accordance with another aspect, the present invention provides an apparatus for a wireless communication network in which the apparatus has a processor and a storage device in operative communication with the processor. The processor operates to create at least a portion of a DHT. The DHT contains mobility management data of at least one mobile device using the wireless communication network. The storage device stores a portion of the DHT.

In accordance with yet another aspect, the present invention provides a system for wireless communication in which there is a plurality of access nodes. Each access node has a processor and a storage device in operative communication with the processor. The processor operates to create at least a portion of a DHT. The DHT contains mobility management data of at least one mobile device using the wireless communication network. The storage device stores a portion of the DHT.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 is a block diagram of a network node used to participate in the DHT; and

FIG. 3 is a flow chart of a process of how an access node participates in the DHT.

### DETAILED DESCRIPTION OF THE INVENTION

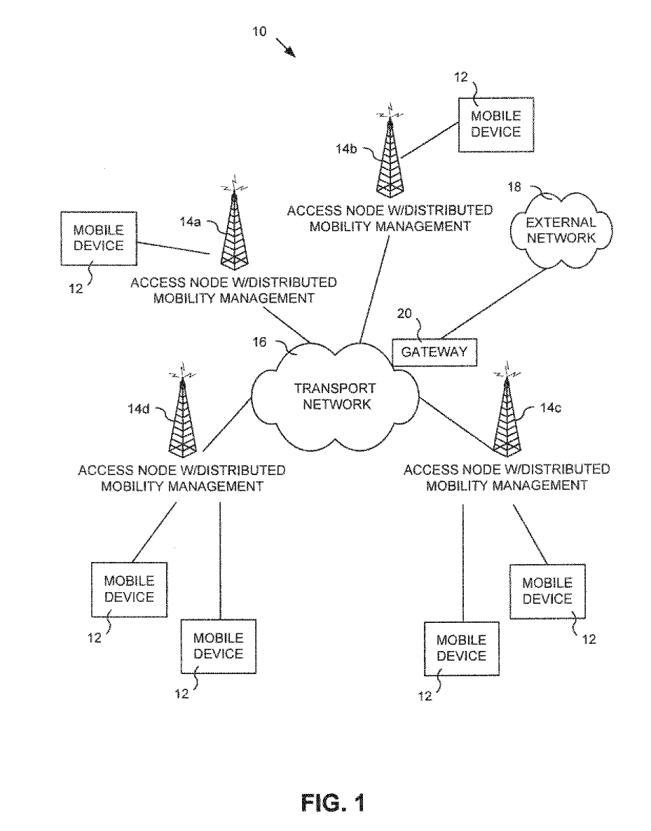

Referring now to the drawing figures in which like reference designators refer to like elements, there is shown in FIG. 1, a system contracted in accordance with the principles of the present invention and designated generally as “10”. Communication system 10 preferably includes one or more mobile devices 12. Mobile devices 12 can be any wireless device capable of performing the functions described herein, including but not limited to handheld wireless devices such as cellular phones, smart phones, PDAs, wireless laptop or tower computers, and wireless vehicular mounted devices. Mobile devices 12 also include the hardware and software suitable to support the functions needed to engage in wireless communication with access nodes 14a, 14b, 14c and 14d (referred to collectively herein as access nodes 14). Such hardware can include a receiver, transmitter, central processing unit, storage in the form of volatile and nonvolatile memory, input/output devices, etc.

Mobile devices 12 are in communication with one or more access nodes 14, e.g., base stations. Access nodes 14 include a central processing unit, transmitter, receiver, I/O devices and storage such as volatile and nonvolatile memory as may be needed to implement the distributed mobility management functions described herein. Access nodes 14 communicate with each other via transport network 16. External network 18 is coupled to transport network 16 and allows communication to and from wireless access network 16 and other local devices such as mobile devices 12. Transport network 16 facilitates communication between access nodes 14 themselves and/or external services available via external network 18 such as Internet access, VoIP services and the like via gateway 20. Arrangements, e.g., protocols and routing, for communication within and between wireless access network 16 and external network 18, e.g., TCP/IP, are known.

The present invention advantageously allows mobility management functions to be distributed among access nodes 14, thereby obviating or minimizing the need for a centralized management platform to perform these functions. In accordance with the present invention, such distribution is facilitated by the use of a distributed hash table (“DHT”). As is described below in detail, the use of a DHT solves the aforementioned problem of scalability because the capacity to handle additional mobile devices 12 and access nodes 14 grows linearly as a number of access nodes 14 in the network increases.

Distributed hash tables are a peer-to-peer technology that are generally known in the art. The general use of distributed hash tables in the present invention is described with reference to FIG. 1. Nodes 14 are considered peers. In accordance with the present invention, access nodes 14 are each assigned a NODEID by applying a cryptographic hash to some unique attribute corresponding to each access node 14. An example of such a unique attribute is an IP address. It is well known that cryptographic hash functions provide an effectively random output with a uniform probability density function. In accordance with one aspect of the present invention, NODEIDs can be 160 bits long as would be obtained using the SHA algorithm. Data is stored in the DHT using a <KEY,VALUE> tuple, where the KEY is created by applying the cryptographic hash function to some attribute of the data. The data can then be located within the DHT by its KEY, and data is stored on nodes 14 with NODEIDs that are close to the KEY. In this case, the term “close” refers to proximity within the generally known concept of distributed hash tables. For example, if the NODEID corresponding to access node 14a is “0112F3” and the node having the next closest key, e.g., node 14d, has a NODEID “4D7F10”, one would go to node 14a to find keys in the range (0112F3, 4D7F10). Routing protocols may be used to maintain the topology between access nodes 14 on wireless network 16 and to traverse the distributed hash table.

The application of a DHT to a wireless system such as system 10 is described. As noted above, access nodes 14 form a DHT. The NODEID for each access point can be performed by hashing a unique id such as the serial number, the IP address, the media access control (“MAC”) address, cell id or sector id of access node 14. In an alternative embodiment, an optional operations administration maintenance system (not shown) can select unique ids for each access point.

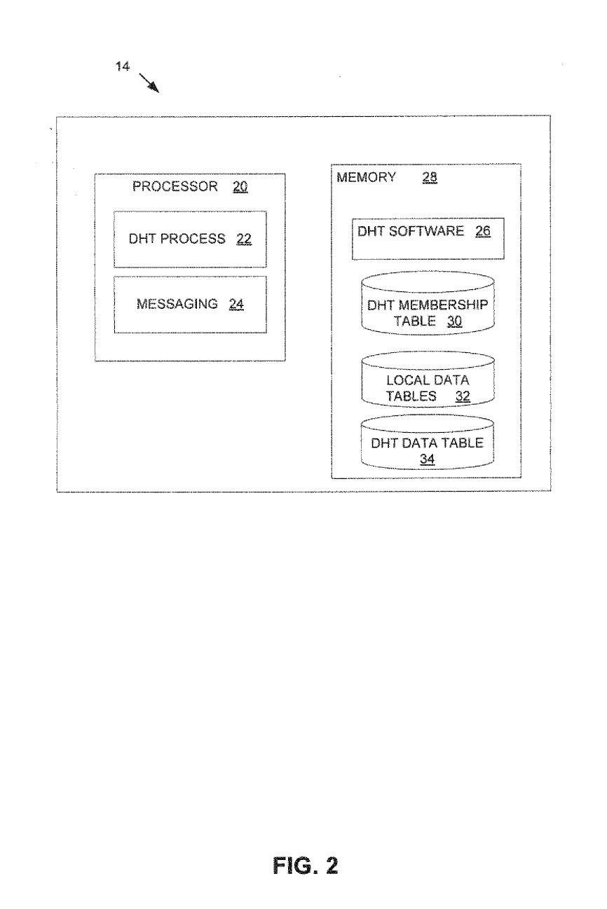

FIG. 2 is a block diagram of an access node 14 constructed in accordance with the principles of the present invention. As shown in FIG. 2, access node 14 includes a processor 20 containing control logic configured to implement a DHT process 22 and a messaging process 24. Messaging process 24 may be used, for example, to format the DHT add message and DHT query messages, to add DHT entries containing routing information into the DHT and to extract entries from the DHT. Other processes may be implemented in the control logic as well. Data and instructions associated with the DHT and messaging processes may be stored as DHT software 26 in memory 28. DHT membership tables, 30, local data tables 32 and remote data tables 34, examples of which are described in greater detail herein, may be maintained in memory 28, in other memory within access node 14, or accessible by access node 14 and stored in external memory (not shown).

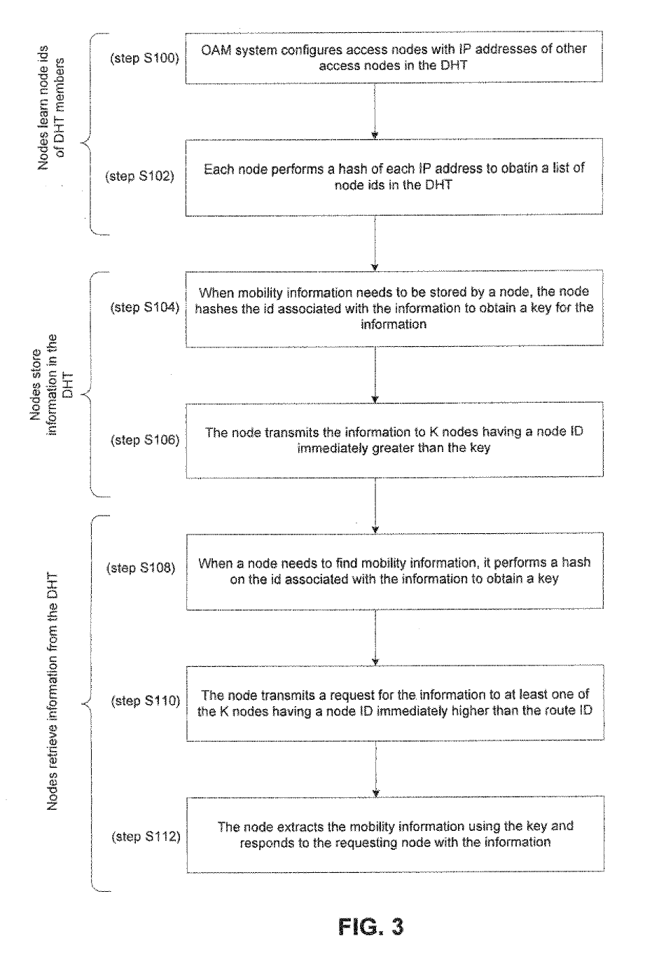

An exemplary process of the present invention is described with reference to FIG. 3. Additional details are set forth below which describe the data structures of exemplary tables that may be used to implement portions of the DHT in accordance with the present invention.

In the embodiment shown in FIG. 3, the OAM system is used to configure access nodes 14 with a list of the access nodes participating in the DHT (step S100). Note that this is only one mechanism of determining which nodes are participating in the DHT. Each access node 14 uses the access NODEIDs to build a DHT membership table 30 (see FIG. 2) which will enable the nodes to determine where queries for particular keys/routes should be sent. For example, each node 14 on the network may have an IP address. The IP address may be hashed to create the NODEID, which may then be ordered to create a membership table (step S102). Although an embodiment of the invention will be described in which the node IP address is used to create the NODEIDs, the invention is not limited in this manner, as other information may be used as the basis for the DHT. For example, each node may have an IEEE MAC address which is used to form the basis of the NODEID.

When an access node 14 stores mobility information in the DHT, it uses a unique key for that information (step S104). In the embodiment described herein, the information is pertinent to a mobile device 12 and that mobile device 12 has a unique IP address which is used as a basis for the key for the information. Access node 14 computes the hash of the IP address for that mobile device 12 using the same hash function that was used to compute the NODEID so that the NODEID and key have the same format and may be easily compared using subtraction or some other mathematical operation. Access node 14 then compares the key with the NODEIDs found in (step S102) to determine which of the node(s) 14 is sufficiently close to the key. Those “K” nodes 14 will be sent a message consisting of a <KEY, VALUE> pair comprising the key for the information and the information itself, which nodes 14 store in the DHT data table 34 (step S106). While this embodiment of the invention uses an IP address as the basis for the key, the invention is not limited in this manner. For example, the mobile device 12 described in this embodiment may have a unique wireless identifier (such as an E-UTRA TMSI) which can be hashed to form the key for the information to be stored in memory 28.

When an access node 14 node needs to RETRIEVE mobility information from the DHT, it obtains the unique identifier for the information and then hashes it to obtain the key using the same process as described in the previous paragraph (step S108). Node 14 determines which of the “K” nodes in the DHT should be used to query the information by comparing the key with the NODEIDs of the nodes in membership table 30. For example, this may be done using the XOR operation described above. Node 14 transmits a request for the <KEY, VALUE> tuple to at least one of the “K” nodes with a NODEID close to the key (step S110). A node 14 that receives the request will extract the route information from its DHT data table 34 and respond with the requested information (step S112).

In order to provide redundant data storage in the event of node failure, the DHT processes may store information on the K nodes with NODEIDs closest to the KEY of the information. In this manner, data will be maintained in DHT in the event of up to K-1 node failures.

The embodiment of the invention described herein assumes that every node 14 in the DHT has the complete DHT membership stored in its DHT membership table 30. The invention is not limited in this fashion and other approaches as may be known for DHT storage may be used to track DHT membership, store information in, and query, the DHT.

Having described above how the DHT is stored and created in access nodes 14, the present invention provides a number of applications for the DHT. These applications include mobile device 12 session management, mobile device 12 location management, diversity handoff, paging and traffic anchoring. Each is described in detail.

### Mobile Device Session Management

When an idle mobile device 12 appears at, i.e., is recognized by, an access node 14, the access node 14 may need to locate session data corresponding to that mobile device 12. This session information includes one or more of security information, billing information, authorization to use the network, etc. The access node 14 serving mobile device 12 can store the location of the access node 14 having the session information for the mobile device 12 in the DHT using the id of mobile device 12 as the basis for the key. This allows other access nodes 14 to use the DHT to locate the session information corresponding to mobile device 12. In this case, the term “serving” refers to the access node 14 that is managing signaling with mobile device 12. This is usually the initial network entry access node 14 for mobile device 12. In this manner, although an access node 14 may be the serving access node, that same access node need not be the access node 14 actually storing the session information for mobile device 12. For example, while access node 14d may be the anchor point for a mobile device 12 within its “cell”, access nodes 14a, 14b or 14c may actually end up being the access node 14 having the portion of the DHT that stores the session information for that mobile device 12.

### Handoff

Handoff refers to the ability of the network to handoff an in progress communication session, i.e., call, from one access node 14 to another access node 14 with minimal disruption to the communication session as mobile device 12 moves. As such, calls need to be homed on a single access node 14 to allow that access node 14 to manage the handoff process. This single access node 14 is responsible for the link control protocol, selecting uplink (mobile device 12 to access node 14) packets, etc. General concepts of handoff in, for example, CDMA networks are known and are not described herein.

What is described herein is the inventive use of the DHT to facilitate diversity handoff. In accordance with the present invention, the DHT can be used to locate the access node 14 serving as the signaling anchor point for the communication session, i.e., homing a particular call. It is noted that the traffic anchor point, i.e., the actual traffic management access node 14, managing the handoff function does not need to be the same access node 14 serving as the signaling anchor point for that session location. In other words, as discussed above, session management is typically performed by the access node 14 at which the mobile device 12 first enters the network. Once the session is established, another access node 14 can serve as the traffic anchor point for diversity handoff. Of note, although the present invention describes separate traffic anchor point and signaling anchor point access nodes 14, the present invention is not limited to such. It is contemplated that a single access node 14 can end up serving as both the traffic anchor point and signaling anchor point depending on the DHT and results of the hashing.

### Mobile Device Location Management and Paging

Access nodes 14 typically need to know where mobile device 12 is within the network, i.e., which access node 14 is currently supporting and providing communication to a mobile device 12. In accordance with the present invention, an idle mobile device 12 can send location updates to the network as it moves. The DHT can be used to store the location updates to allow access to this information from any access node 14.

When incoming traffic arrives for an idle mobile device 12, that mobile device 12 needs to be paged to locate it within system 10. The DHT can be used to look up the last known location of mobile device 12 to initiate paging. Location in this case refers to the last known access node 14 supporting communication with the mobile device 12.

If mobile device 12 can't be found at its last known location, mobile device 12 needs to be paged across system 10. The DHT membership information can be used to flood the page request in a structured manner by partitioning access nodes 14 using their DHT NODEIDs. In accordance with one example, the anchoring access node 14 can flood the paging request to all of the access nodes 14, e.g., all access nodes 14 in system 10 which then page mobile device 12. This brute force method provides the most rapid page, but with an increased load on the anchor access node 14 due to the flooding processing that must be performed as well as the traffic generation which is subsequently flooded across wireless access network 16.

As another example, the anchor access node 14 can partition the access NODEID space into a binary tree and forward the paging request to two other access nodes 14. Each of these access nodes 14 forwards the request to two more access points, etc. This arrangement provides for a slower paging process, but provides a well-distributed load on all access nodes 14. In each of the above examples, all access nodes 14 in the system 10 end up paging mobile device 12.

In accordance with another aspect, distance-based paging can be performed. With distance-based paging, all access nodes 14 within a specified distance of the last known location of mobile device 12 initiate the page. These access nodes 14 can store their geographical location using a reference grid or some other tessellation as the basis for the key in the DHT. The access node 14 initiating the page can query the appropriate grid squares in order to find other access nodes 14 within the predetermined distance for paging.

As still another example, zone-based paging can be performed. With zone-based paging, the network is sub-divided into smaller logical portions. Access nodes 14 store their identities against their corresponding assigned paging zones in DHT, i.e. using the paging zone id as the basis for the key. The initial access node 14 initiating the page can query the DHT for the paging zone to retrieve all of the access nodes 14 within that paging zone. The access nodes 14 within that paging zone can then be instructed to initiate a page to mobile device 12. If the page is still unsuccessful, the initial access node 14 can query the DHT for another paging zone to continue iteratively paging.

### Traffic Anchoring

The DHT can be used to support a function in which traffic originating on external network 18 is communicated with mobile device 12 via gateway 20. In this case, gateway 20 needs to know which access node 14 is the traffic anchor point for mobile device 12 so that traffic can be efficiently routed from gateway 20 to access node 14 supporting the communication session with mobile device 12.

When inbound traffic is detected by gateway 20, gateway 20 retrieves the identity of access node 14 anchoring mobile traffic from the DHT. Gateway 20 is then able to route the inbound traffic to the anchor point for the mobile device.

In accordance with the present invention, the use of a DHT on access nodes 14 allows for the storage of mobile device 12 information in the DHT such that the use of a centralized management control device is not needed. The DHT can be used in connection with add, query and update operations, as discussed above to store, retrieve, and/or change the mobility management data and to perform a mobility management function described above.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for management of a wireless communication network having a plurality of access nodes, the method comprising:
creating a distributed hash table (“DHT”), the DHT containing mobility management data for the wireless communication network; and
storing the DHT across at least a portion of the plurality of access nodes.

2. The method of claim 1, wherein creating the distributed hash table includes assigning a NODEID to each node storing at least a portion of the DHT, each access NODEID being based on a unique identifier corresponding to the access node.

3. The method of claim 1, wherein creating the distributed hash table includes
creating a key for information to be stored in the DHT, the key identifying the access node storing a portion of the mobility management data.

4. The method of claim 1, wherein the mobility management data includes mobile device session information.

5. The method of claim 4, wherein the mobility management data includes an identity of the access node storing the mobile device session information.

6. The method of claim 1, wherein the mobility management data includes location data corresponding to a mobile device.

7. The method of claim 1, wherein the mobility management data includes an identity of an access node storing location data of a mobile device.

8. The method of claim 1, wherein the mobility management data includes an identity of a serving access node for handoff of a mobile device.

9. The method of claim 1, wherein the mobility management data includes access nodes within a paging zone, wherein a paging zone id is the basis of a DHT key.

10. The method of claim 9, further comprising:
evaluating the DHT to determine a paging zone; and
instructing access nodes within the determined paging zone initiate a page to the mobile device.

11. The method of claim 10, further comprising:
evaluating the DHT to determine access node membership when paging is unsuccessful; and
transmitting a flooding paging request to all access nodes.

12. The method of claim 1, further comprising:
storing the traffic anchor point for a mobile device in the DHT; and
retrieving the traffic anchor point for the mobile device in the DHT in order to route traffic to the mobile device.

13. An apparatus for a wireless communication network, the apparatus comprising:
a processor, the processor operating to create at least a portion of a distributed hash table (“DHT”), the DHT containing mobility management data of at least one mobile device using the wireless communication network; and
a storage device in operative communication with the processor, the storage device storing a portion of the DHT.

14. The apparatus of claim 13, wherein the apparatus has a hash key, the hash key being based on a unique identifier corresponding to the apparatus.

15. The apparatus of claim 14, wherein the mobility management data includes a location of a mobile device, where the processor further operates to update the DHT to store mobile device location updates.

16. The apparatus of claim 14, wherein the processor further operates to:
evaluate the DHT to determine a last known access node engaged in wireless communication with a mobile device; and
transmit a request to the last known access node to page the mobile device.

17. The apparatus of claim 16, wherein the processor further operates to:
evaluate the DHT to determine access node membership when the paging is unsuccessful; and
transmit a flooding paging request to all access nodes.

18. The apparatus of claim 17, wherein the DHT includes paging zone information, wherein the process further operates to:
evaluate the DHT to determine a paging zone;
instruct access nodes within the determined paging zone initiate a page to the mobile device.

19. A system for wireless communication, the system comprising:
a plurality of access nodes, each access node having:
a processor, the processor operating to create at least a portion of a distributed hash table (“DHT”), the DHT containing mobility management data of at least one mobile device using the wireless communication network; and
a storage device in operative communication with the processor, the storage device storing a portion of the DHT.

20. The system of claim 19, wherein each of plurality of access nodes has a corresponding NODEID, each corresponding NODEID being based on a unique identifier of the access node.
